(19) United States
(12) Patent Application Publication
(10) Pub. No.: US 2005/0170315 A1
(43) Pub. Date: Aug. 4, 2005

(54) System, method, computer program product and apparatus for producing dental restorations

(76) Inventors: Wolfgang M. Strobel, Tolland, CT (US); David J. Gerber, West Hartford, CT (US)

Correspondence Address: MORGAN & FINNEGAN, L.L.P., 3 World Financial Center, New York, NY, 10281-2101, US

(21) Appl. No.: 11/039,133

(22) Filed: Jan. 18, 2005

Related U.S. Application Data
(60) Provisional application No. 60/538,048, filed on Jan. 20, 2004.

(51) Int. Cl. A61C 13/08

(52) U.S. Cl. 433/203.1

(57) ABSTRACT

Systems, methods and computer program products for producing dental restorations that can include the use of a computer integrated manufacturing system. Using this system, physical properties of a tooth are collected, for the automated manufacturing of a dental restoration. The invention, in one embodiment, includes creating a color map comprising at least one color value, a computer program product for producing a dental restoration layer, as well as a method for producing a dental restoration using a computerized system.

### CROSS REFERENCE TO RELATED APPLICATION

This application claims the benefit of U.S. provisional application 60/538,048 filed Jan. 20, 2004, entitled “Method and Apparatus for Producing Dental Restorations”, which is copending. This aforementioned provisional application 60/538,048 is incorporated by reference herein in its entirety.

### BACKGROUND OF THE INVENTION

1. Field of the Invention

This invention applies to dental restorations and to methods, systems, computer programs and apparatus for producing dental restorations.

2. Background Information

Dental restorations such as crowns and bridges are used in dental care to restore a tooth or group of teeth to an aesthetically pleasing properly functioning form. The traditional process for making dental restorations is labor intensive and requires a number of steps. In an initial step, the tooth is shaped by removing material until a profile is created which can receive the restoration. The shaped tooth is typically referred to as the preparation. Once the shaping process is complete, an impression is made of the preparation and that impression is subsequently used to form a model of the preparation. At some point in the process, impressions are also made of the teeth disposed on the side, above, or below the subject tooth. A coating material is painted by hand on the preparation model to provide a suitable gap for the adhesive, which will ultimately be used to secure the restoration-to the preparation. A wax model of the coping is then built on top of the preparation model. Wax models of the adjacent teeth can also be made from the impressions. The wax model is sculpted in the general shape of the tooth, but the outer features are slightly undersized. A green ceramic mold of the finished wax model is subsequently made to be used in an investment casting process. Once hardened, the wax model is evacuated from the green ceramic mold, which is then subsequently fired. The fired mold now provides a cavity for receiving a molten metal material which will form the substrate for the restoration which attaches to the preparation. The substrate is typically referred to as a “coping”. The “coping” is the understructure of a restoration. The term “framework” refers to a multitooth, or more complex, understructure. The term “coping” as used herein equally embraces both single and multitooth understructures, as well as more complex dental understructures. In some applications, the understructure is made from a non-metallic material such as a ceramic. The terms “coping”, “framework” and “understructure” are used herein interchangeably.

Layers of ceramic material are applied to the coping (understructure, framework) to give it the appearance of a natural tooth. The layers are each created using colored ceramic materials specifically chosen to match the patient's adjacent teeth. The traditional methodology for applying the ceramic layers involves a skilled technician creating the appropriate color layers and applying them to the understructure. Some or all of the ceramic layers are also sculpted by hand to give the restoration its final shape. The sculpting process involves a skilled technician selectively removing ceramic material to create the desired final shape. The accuracy of the final shape contour affects whether the restoration not only looks appropriate relative to the adjacent teeth, but also whether it meshes well with adjacent teeth. This process is an iterative, labor-intensive process which requires a skilled technician. The finished restoration is then finally bonded to the tooth preparation.

To arrive at the desired colors, the technician begins with a understructure and a color specification (or prescription) provided by the patient's dentist. In the traditional methodology, the dentist uses a manual comparison of color samples to a tooth, or adjacent teeth, to determine the specification. This color comparison process and consequent specification is completely subjective.

Ceramic powders are selected to prepare the color which has been specified (or prescribed). Typically, this process requires the technician to add various different color materials together iteratively until the desired color is produced. This technician mixing step is a source of error leading to improper colors and a further consequence of this iterative practice is more material is usually mixed than is needed. This extra material cannot be saved, so the expensive ceramic material is discarded and the cost of the process is undesirably increased.

### BRIEF SUMMARY OF THE INVENTION

This invention is an advance in the art of dental restorations. The current invention includes the manufacture of dental restorations utilizing computer aided design (CAD), computer integrated manufacturing systems (CIM), computer assisted manufacturing or milling (CAM), CAD/CIM and CAD/CAM systems, data acquisition and management systems from the step of initial data acquisition based upon patient or product requirements through finishing and quality control of the final product. The invention, in some of its aspects, can utilize computer processes to acquire physical property data for a desired restoration, determines color, physical property, topographical requirements, physical requirements throughout the tooth and its structure, and can create final products and restorations utilizing inventive computer integrated manufacturing processes and systems.

Physical products of the invention include, but are not limited to restorations, and the work-in-progress products of the restoration manufacturing process. An understructure, in one non-limiting embodiment, is a cap which can be constructed from a metal, a ceramic, or other material which can be finished with coatings, and which can be attached to a preparation. A preparation can be a shaped receiving object, such as a patient's tooth, or a post.

A “coping” as referred to herein is the understructure of a restoration. In other words, a coping is the understructure on which the final restoration is constructed. As used herein “understructure” encompasses any coping, framework, structure, support or surface which is processed into a restoration by having materials, colors, colored materials, or other substances (e.g., bonding agents) applied thereto, or activities conducted thereon. It will be understood that herein the term “understructure” applies equally to embodiments for an individual tooth, as well as for more complex items such as multiple teeth, and complex oral structures, physical objects, and morphological or dental features.

A dental restoration (restoration) can be temporary or permanent. A dental restoration is any substance or structure that replaces, improves, enhances or modifies a patients tooth, teeth, or any part thereof. A restoration includes any substance, material or structure which is upon, engaging, affects, decorates, or interacts with, an understructure. A dental restoration also includes any substance or structure which relates to the appearance, morphology, abilities, operation, control and state of a patients tooth, teeth, or mouth. Examples of restorations encompassed by this invention include, but are not limited to, copings, dental crowns, partial crowns, veneers, bridges, implants, composites, partial or full dentures, implants, abutments, disks, cylinders, and connectors, replacement teeth, orthodontic retainers, bridges, space maintainers, tooth replacement appliances, splints, seals, sealants, fillings, inlays, onlays, facing, veneers, facets, orthodontic appliances, space maintainers, tooth replacement appliances, splints, posts, teeth, and jackets. A person having ordinary skill would understand that restorations in addition to those of this list are encompassed by this invention.

Dental restorations can be manufactured from a broad variety of materials which are embraced with the processes and methods of this invention. These materials of manufacture include but are not limited to glass powders, glass, glaze, glass frit, ceramic materials, glass-ceramics, lithium disilicate (Li₂Si₂O₅) based glass-ceramics, mica-containing ceramics, micaceous glass ceramics, resins, bonding materials, adhesives, metal, metal alloys, porcelain powders, porcelain, porcelain fused to metal (PFM), dentine, dental alloys, plastics, leucite crystallites, alumina, sapphire, and colorants.

An advantage of the present invention is that the cost of producing a dental restoration such as a crown or a bridge is reduced by the above-described method, relative to presently known methods, by minimizing waste materials. The present method produces the quantity of ceramic material necessary in the color required.

Another advantage of the present method is that it requires less subjective input than presently known methods because the color map is created electronically, and the ceramic material color is created according to the color map. Hence, the subjectively of a person creating a color specification (or prescription) according to a human eye is eliminated, and the manual mixing process for the ceramic material is greatly reduced or eliminated. The amount of the time and labor necessary to produce a dental restoration such as a crown or bridge is also greatly reduced.

Further the present method requires less subjective input than presently known methods because it decreases the amount of sculpting required by a skilled technician. Because ceramic material is applied only where required, there is less, if any, material to remove to ensure appropriate aesthetic appearance and physical fit relative to adjacent teeth. In addition, in those instances where different color ceramic layers are built upon one another, the present method provides a method that minimizes coloration problems that arise when ceramic material is removed, exposing earlier applied differently colored layers.

In one embodiment, a method, system and apparatus for producing a dental restoration material is provided. The method includes the steps of: creating a restoration color map, wherein the map specifies one or more predetermined color values at particular positions on the restoration, and a quantity magnitude of the predetermined color values; determining a mix recipe for each predetermined color value specified within the restoration color map; and creating an amount of ceramic material for application to an understructure using the mix recipe and the quantity magnitude of the predetermined color value. Ceramic material may be applied one time, or multiple times using this system and method.

In another embodiment, the present invention includes a method for producing a dental restoration, comprising the steps of creating a color map comprising at least one color value, determining a mix recipe for said at least one color value, and preparing an amount of color material from said mix recipe.

In yet another embodiment, the present invention includes a method for creating a dental restoration layer, comprising collecting color data from a patient tooth, creating a color map utilizing said color data, creating mix recipe data from comparison between said color data in said color map and color library data, creating said color mixture from said mix recipe, and applying said color mixture in a thickness upon a surface forming a layer. The color mixture can be non-uniform and can have a variance of color. The thickness applied to the surface can be non-uniform. Thus, both the thickness of the applied material to the surface can vary and the layer which is formed can be non-uniform and of varying thickness and topography.

A further embodiment of the present invention includes, a computer program product for producing a dental restoration layer, including a least one processor capable of executing program code and comprising a computer readable medium and program code in said computer readable medium for processing steps comprising collecting color data from a patient tooth, creating a color map utilizing said color data, creating mix recipe data from comparison between said color data in said color map and color library data, creating said color mixture from said mix recipe, and applying said color mixture in a thickness upon a surface forming a restoration layer.

In one aspect, the invention can include a system for producing a dental restoration having a data collection unit, a data processing unit producing a manufacturing instruction, and a manufacturing device. Further, the data collection unit can produce a manufacturing instructed based upon data from said data collection unit, the data processing unit can produce at least one manufacturing instruction, and the manufacturing device can execute said manufacturing instruction to affect an understructure in the production of a dental restoration.

In a still further embodiment, the present invention includes a method for producing a dental restoration layer using a computerized system, the computerized system including a memory and a processor capable of executing program code, the program code being used to perform steps, the steps comprising collecting color data from a patient tooth, creating a color map utilizing said color data, creating mix recipe data from comparison between said color data in said color map and color library data, creating said color mixture from said mix recipe, and applying said color mixture in a thickness upon a surface forming a restoration layer.

The system for producing a dental restoration can support and/or execute steps not limited to creating a first color map for a first restoration layer, applying a first color material based upon said first color map to form said first restoration layer, evaluating said result of said applying a first color, creating a subsequent color map for a subsequent restoration layer based upon said evaluating, applying a subsequent color material based upon said subsequent color map to form said subsequent restoration layer.

Where the system processes a restoration topography. The system for producing a dental restoration can support and/or execute steps not limited to, creating a first topographical map for a first machining step to an understructure or to a restoration layer, executing said first machining step based upon said first topographical map, evaluating said result of said first machining step, creating a subsequent topographical map for a subsequent machining step based upon said evaluating, executing a subsequent machining step to an understructure, or to a restoration layer, based upon said subsequent topographical map. The system of manufacturing encompasses embodiments in which a variety of material application steps and material removal steps are executed. In one embodiment the system can be utilized for creating a topographical map for a restoration layer, determining an amount and location of material to be applied based on the topographical map, and applying the material to form the restoration layer. The restoration layer which has been applied can then optionally be machined to remove or affect the material which has been applied. Whether or not machining of the applied material occurs, a subsequent topographical map can be created for the applied restoration layer. Subsequent material can be applied based upon the subsequent topographical map. Any subsequent material which is applied can also be machined. The process steps of applying material in manufacturing a restoration and machining can be performed as many times as desired.

### DESCRIPTION OF THE DRAWINGS

FIG. 1A is an illustration of one embodiment of a property data map.

FIG. 1B is an illustration of one embodiment of a color data map.

FIG. 1C is an illustration of one embodiment of a topographical data map.

FIG. 2A is a flow chart of process steps of one embodiment for creating a data map.

FIG. 2B is a flow chart of process steps of one embodiment for creating a color map.

FIG. 2C is a flow chart of process steps of one embodiment for creating a topographical map.

FIG. 3 is an illustration of a dental restoration manufacturing system.

FIG. 4 is a flow chart of one embodiment of process steps for creating an amount of mixed ceramic material

FIG. 5 is an illustration of one embodiment of an apparatus for creating a ceramic mix.

### DETAILED DESCRIPTION OF THE INVENTION

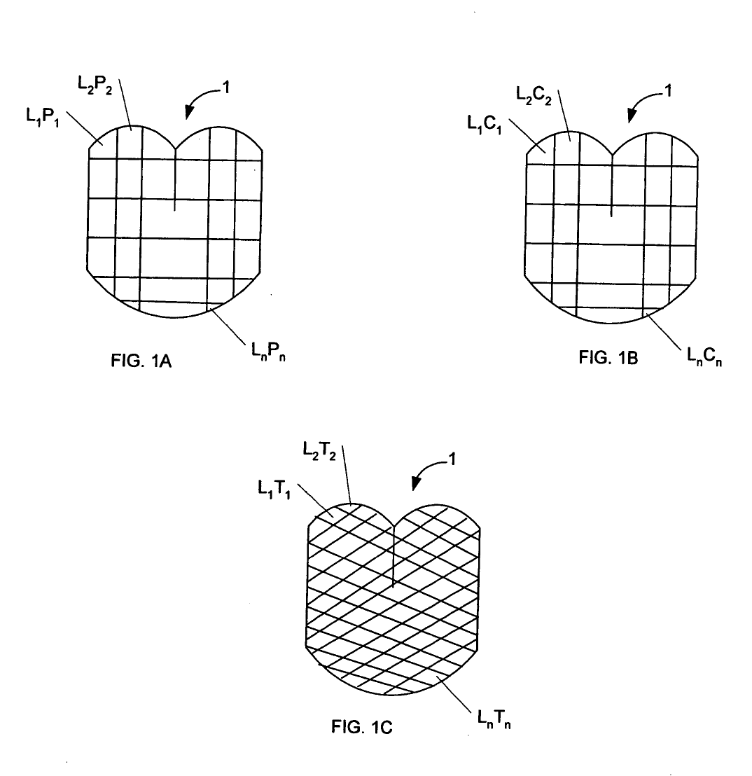

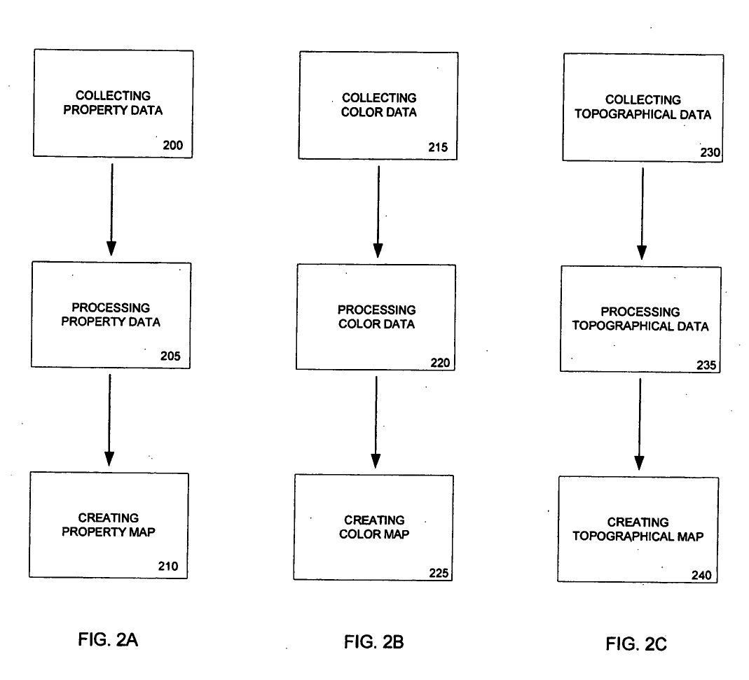

FIG. 1A illustrates a property data map. In general, a data map (map) relates data or a collection of data. A tooth has a number of attributes each of which can be utilized and processed by this invention. In one embodiment data maps are utilized to manage data related to one a specimen which may be a patient's tooth, teeth, or an aspect of dental topography or morphology (FIG. 1A, FIG. B, FIG. 1C, FIG. 2A, FIG. 2B, FIG. 2C). The data management for an individual tooth or preparation may also be for multiple teeth and more complex dental topography and morphology. In a non-limited example, a data map for a tooth can relate a piece of data regarding the tooth to a specific location on or within the tooth itself or mouth.

In one embodiment at least one data map of a tooth is created. A tooth has attributes. The attributes and properties of a tooth can include, but are not limited to: color, color shade, translucence, transparency, brightness, fluorescence, opacity, opalescence, hue, chroma, shine, reflectivity, reflectivity, spectral reflectivity, color and/or light absorbtion, topography, texture, density, composition, location in mouth, name, identification, relational data, as well as other characteristics a person having ordinary skill would associate with a tooth, teeth or the mouth. A data map can be created for any property of a tooth.

FIG. 1A illustrates the creation of a property map of a tooth. The data of the map can range from one data point to any number of points, or as many as utilized technology will allow, or are desired. Data can also be one, two or three dimensional in nature. In FIG. 1A the property map is created by associating a property value with each location desired on the tooth. Property “P” (which can be any desired property) has a value P₁ at location “L₁”, L₁P₁. P has a value P₂ at location L₂, L₂P₂. This data processing proceeds at locations L₁ thru Lₙ, LₙPₙ recording the property value at each point, i.e., L₁P₁ . . . LₙPₙ. The property map can be represented graphically, held in database form, processed and used by the processes and systems disclosed herein. The property mapped from a source not limited to a tooth, or teeth, can be any property desired including, but not limited to any of the attributes and properties of a tooth identified herein.

FIG. 1B illustrates the creation of a color map for a tooth Color is a specific property of a tooth in accordance with one embodiment of the present invention which can be mapped. Color, “C”, has a value C₁ at location “L₁”, L₁C₁. C has a value C₂ at location L₂, L₂C₂. This data processing proceeds at locations L₁ thru Lₙ, LₙCₙ recording the color value at each point, i.e., L₁C₁ . . . LₙCₙ. A color map can be processed to create mix recipes which will govern the mixing of color material which will be utilized in preparing a restoration.

The term “color” as used herein refers not only to the pigment material (e.g., a ceramic), but also to the qualities, attributes and characteristics of the material that will create the translucence and opalescence that are normally seen in natural teeth. Where a specific component of color component, or tooth property, is desired, that component can be analyzed and mapped.

Herein the term “topography” includes both the topography and topology of a tooth, restoration, or physical object. The term “topography” encompasses the surface features of an object and has depth. Where “topology” exists in regard to the anatomy of a physiological area, any such “topology” is encompassed within the definition of the term “topography”. The term “topography” is understood to encompass both the physiological aspects of a tooth, or physiological area, as well as the physical features, surface, or depth of structure of any object. The term “topography” is not limited to the analysis of surface features and surface points. As previously stated, the term “topography” as used herein encompasses depth which includes, but is not limited to, a geometrical depth and/or a depth of structure, or physical characteristic (physical attribute). The term “topography” encompasses the physical characteristics, attributes, forms and structures of both inanimate and physiological objects and structures. The term “topographical” is defined as broadly as “topography” and can be used interchangeably. In one non-limiting example of usage herein, a “topographical” map can be created by this system of either a patient's tooth and its structure, or of a final restoration and its structure.

It is contemplated in another aspect of the invention, a tooth has topographical characteristics (e.g., shape, contours, topography, features, cavities, dimensions, dimensional characteristics, tooth structure). The topography of a tooth can be utilized in preparing a restoration. Each physical location of a tooth has a position in X, Y, Z coordinate space where X=0, Y=0 and Z=0, or one or more other coordinates, can be used as a reference point(s). The location of a point of a tooth in space as compared to a reference point(s) is considered a topographical point “T”. The point T has a location associated with its location on a tooth, or specimen, “L”. The topographical mapping of a tooth can produce surface maps, 3-dimensional (3-D) maps and identify textures, cavities and surface features of a tooth. 3-D maps can create, or be used to create, 3-D electronic profiles and manufacturing specifications and instructions. Such electronic maps, profiles, or portraits which may be utilized by machine tools and processing systems (FIG. 1C) illustrate the creation of a topographical map of a tooth. T, has a value T₁ at location “L₁”, L₁T₁. T has a value T₂ at location L₂, L₂T₂. This data processing system proceeds at locations L₁ thru Lₙ, LₙTₙ recording the topography value at each point, i.e., L₁T₁ . . . LₙTₙ.

FIG. 2A is a flow chart of an embodiment for creating a property map in accordance with one embodiment of the invention. A property map is a generic term for creating a map of any one, or more, properties of a source object including, but not limited, to a tooth (1), teeth or other item. FIG. 2A illustrates data is collected (200) by a collecting means, for example, but not limited to a digital camera, photospectrometer, calorimeter, or spectrocolorimeter. The source data is processed (205) and a property map is created (210) for the desired property. In a further embodiment, a color map is created by collecting color data (215) from a source, such as but not limited to a tooth (1), teeth or other item. The collected color data is processed (220) and a color map is created (225). In yet another embodiment, a topographical map is created by collecting topographical data (230) from a source, such as but not limited to a tooth (1), teeth or other item. The collected topographical data is processed (235) and a topographical map (240) is created.

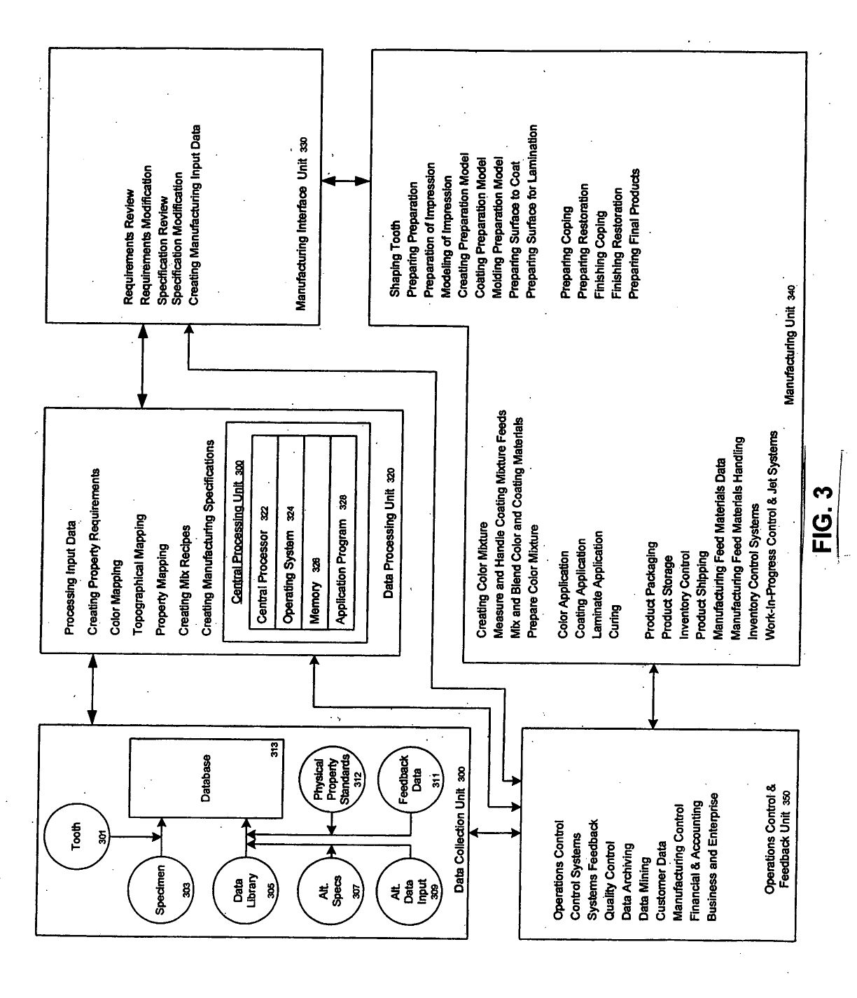

FIG. 3 illustrates a dental restoration manufacturing system in accordance with one embodiment of the present invention. As illustrated in FIG. 3, the system includes, but is not limited to a data collection unit (300), a data processing unit (320), a manufacturing interface unit (330), a manufacturing unit (340) and an operations control and feedback unit (350). A broad variety of system architectures, equipment, machine tools, input devices, processors, machines, user interfaces, manufacturing processes and control systems are encompassed by the present system and the processes, methods and system design. In one embodiment, the system can comprise a central processing unit (CPU) (321), central processor (322), an operating system (OS) (324), computer memory (326) and at least an application program (328). Input and output means and devices can also be utilized. The CPU, OS, memory and application programs function together in the system.

The equipment and machines to run the applications, collect data, manufacture products and control the manufacturing and business operations is associated with each respective function and process illustrated in FIG. 3 are encompassed in the present invention. The system can be employed to perform one, some, or all, functions disclosed in FIG. 3 and throughout this disclosure. The system can include computer architecture consistent with a related activity, e.g., creating color maps, creating property maps, creating topographical maps, creating mix recipes, preparing color mixtures, manufacturing coping and restorations, operations control and process feedback. Each of these function can be a stand alone system in the context of this disclosure, or can be combined with additional systems and unit operations. For example, the data processing unit (320) is operable to execute computer program code to perform one, some or all functions disclosed herein.

The data collection unit (300) can collect a variety of data utilized by the system. In one embodiment, color data is collected from an individual tooth (301), or specimen (303), either manually or electronically and received as data input to the system. Color data may also be accessed from a data library which is pre-established, concurrently entered, or dynamic. Pre-established standards and manual data entry can be supported. Technological means and devices can be utilized to collect property data from a tooth and provide it to the system. These means and devices include, for example, but are not limited to, a digital camera, a colorimeter, a photospectrometer, or the like. In one embodiment, a colorimeter, or spectrophotometer is utilized to acquire the electronic data describing the particular colors of a tooth.

In one embodiment, topographical data is collected from an individual tooth (301), or specimen (303) either manually or electronically and received as data input. The topographical data for an individual tooth can be collected from a pre-established data library (305), standards (312), entered manually, or may be collected by technological means. Additional sources of input data can include photographs, models, molds, and digitized photographs.

Devices can be utilized to collect topographical data from a tooth. These devices include, but are not limited to 3-D cameras, scanning devices including 3-D scanners, and manual measurements. This topographical input data can be processed to create a topographical map, or 3-D map, directly by electronic processing, or can be prepared manually. The system supports entry of manually created topographical maps for utilization in the preparation of a restoration.

The data input system can receive input from one or more of a variety of sources. Examples of data sources include, but are not limited to, data from physical items such as a tooth (301), teeth, or a specimen (303), which are either manually or electronically entered. Alternative specifications (307), alternative data input (309), such as manual input and feedback data (311) can be utilized. Library data can be used from a data library (305) which may include, but is not limited to library tooth/teeth data, library topography data, library morphology data, Equipment including digital cameras, calorimeters, spectrophotometers, spectrocolorimeters, alternate imaging or mapping equipment can be used to provide data input into memory (326) or to be processed by the central processor (322) of the central processing unit (300), the operating system (324) will operate the central processing unit (322) to run applications for processing the input data into any of a number of outputs including property maps, mix recipes, and manufacturing requirements and specifications. Input data further includes, but is not limited to, tooth specifications, physical property standards, alternate data input from other sources or systems, control and feedback data can also be input for, stored in or utilized by the system.

Prior to manufacturing a restoration, input data can be processed in a data processing unit (320). The system can create property maps from a data source such as, but not limited to, a tooth and can create property maps for a restoration, or other product of manufacture, such as an understructure. These original and revised product maps can be referred to as source property maps and target property maps. Generally, the term “source” as used herein refers to the origin, physically or electronically, of a piece of data (upstream information or processing). The term “target” refers to a downstream requirement, product, activity, data or information which is to conform to a purpose, meaning, activity, requirement or specification. For example, a source property map can be a property map of a sample tooth. A target property can be exemplified by the color map which is to be achieved for a restoration in conformance with manufacturing specifications or requirements for color. A target color map can be the same as a source color map, or it may be different. A system operator can modify both source and target color maps. Target maps can also be manually created and entered into or utilized with the system.

The data processing unit (350) can process one or multiple sources of data input, for example but not limited to, equipment, analyzers, data libraries and manual sources. Applications programs for collecting and managing data, creating properties maps, creating mix recipes and be run in the data processing unite (340). The system can generate manufacturing specifications for any desired property of a restoration to be produced. Color and topography are non-limiting examples of such properties. The can support manufacturing aspects related to color determination and application including, but not limited to color data input to create color maps, process color requirements, create color palettes, create mix recipes, creating color mixture, measure and feed coating mixture feed materials mix and blending of color materials, prepare final color mixture, application of coatings and applying laminates.

In one embodiment, color is an input data and is collected to create a color map for use in color mixing and manufacturing. This color input data can be processed to create a color map directly by electronic processing, or a color map can be prepared manually. The system supports entry of manually created color maps for utilization in the preparation of a restoration.

Target color maps can be for coatings, layers, laminates, restorations or any surface to be colored. During the manufacturing process color maps can be made for work-in-progress and compared to existing calculated, desired, or target color maps, and a comparison can be made. The system allows for this feedback and control step. Further, a system operator can vary data of the color maps.

In one embodiment, a restoration having a target color, or color map, is manufactured. To manufacture a restoration with the target color, or target color map, the system can be utilized to generate a mix recipe. A mix recipe can be generated manually, or manually with the support of a color library data contained in the system, or manually with the support of a color map generated by the system, or a combination of input sources. A restoration color map is created, wherein the map specifies one or more predetermined color values at particular positions on the restoration, and a quantity magnitude of the predetermined color values. The map can be made by a technician visually selecting colors by comparative method with the patient's existing teeth.

A mix recipe can be generated electronically by the system. When a target color, or target color map is desired, a mix recipe for each target color value specified within the restoration color map can be created. The system operator can determine the number of colors and the spectrum (palette) of colors for which mix recipes will be generated. The system can support the manual generation of mix recipes from either manually entered color data or system created color maps. If the color map is created manually, each color value from the map can be associated with a particular mix recipe. The system can create the color recipes for the user, or can access a predetermined mix recipe from a mix recipe library.

A “mix recipe” (MR) (also known as a “blend” or “formulation”) is an instruction which can be produced by an application of the data processing unit which provides one or more specifications or requirements for selecting, mixing, or making an amount, of any color, pigment, color material, tint, hue, shade or effect. A mix recipe may be custom made based upon input data, pre-established and stored in memory, or provided by another system.

Generally, any material which has a color and is identified in a color mix is referred to as a “color mix material” “colorant”. Color mix materials also include materials which can be free of color, non-color, varying in color, reflecting color, white, black, or which serve a purpose unrelated to the color, optical density, or nature, of the amount of colored material being mixed. A mix recipe can contain one, or more color bearing materials.

The system is not limited by the phase or condition of mix materials. The system can mix solids and solids, powders and powders, liquids and liquids, amorphous and indeterminate phases, as well as multi-phase substances, or any combination of these phases. In one embodiments, colored powders are mixed together, in another embodiment pigments are mixed together. Pigments can be added to pigments, liquids, powders, or any phase of material. The system also can mix a pigment and a powder, two or more pigments, or a pigment and a multiphase colored material. The system can support the mixing of any color bearing materials. Further, the system is not limited in the number of color bearing materials (color mix materials) which are to be mixed or blended. Large libraries of colors can be used and supported by the mixing machinery and the computer systems (e.g., data collection unit (300), CPU (320), manufacturing interface unit (330), manufacturing unit (340) and the operations control and feedback unit (350)).

The mix recipe can also specify effects or characteristics of the amount of color material not related to its pigment or color. Additives can, but are not limited to, include solids, cosmetic materials, decorative materials, metals, precious metals (e.g., gold) fibers, metals, hardeners, solvents, opacifiers and metal oxides (e.g., but not limited to, Al₂O₃, SnO₂, TiO₂, ZrO₂, ZrSiO₄, ZnO, CeO₂, Ta₂O₅, SiO₂, B₂O₃,CaO, MgO, BaO, Li₂O, K₂O, Na₂O), F, Au, inorganic fillers such as, but not limited to, leucite and CaF₂, fluorescing agents.

Pharmaceuticals, therapies, drugs, antiseptics and compounds to protect the teeth, such as fluorides may also be included in the mix recipe.

A mix recipe can contain, but is not limited to, one, more or all of the following information: one or more color bearing materials, amount of material to add, mixing and blending requirements, source of color bearing material, materials handling instructions, application instructions.

Each color which is used in preparing a restoration can have one or more mix recipes. Each amount of color material can be designated to be applied to a particular location on a target surface. In an embodiment utilizing a color map, each point on the color map can be associated with a different mix recipe. For example, L₁C₁ can have an associated mix recipe, (MR₁), L₂C₂ can have an associated MR₂, . . . LₙCₙ having an associated MRₙ. The number, or density, of data points on a color map and the number of associated mix recipes can vary widely from one, to a desired number, or as many as the data processing unit will allow.

A mix recipe can include information related to the location on a surface, and means by which an amount of colored material is to be applied. Where a color map is utilized the mix recipe can identify relational information for the color map, such as an identification, number, patient identification, restoration identification and target surface information. Further, in embodiments where more than one layer, coating, laminate, or application is utilized, the mix recipe can also include information regarding to which layer and at which application location(s) the amount of colored material of the mix recipe is to be applied.

Mix recipes also can have dimensional factors. A mix recipe can relate a particular color mix to a point, a two dimensional surface, or to a 3-dimensional application. In embodiments having complex topography, occlusions, multiple layers, or surface preparation the mix recipe can include instructional information for applying an amount of colored material on, or within, the aforementioned surfaces and structures.

A mix recipe can be determined by using the electronic data of the color map to match particular color values to particular predetermined ceramic material mix recipes. A mix recipes can be for a standard color where no additional mixing is required, or can be for a custom colors that are created by combined predetermined portions of more than one different standard colors. Mix recipes may contain specifications for one or more target colors. Where a source color, or a target color, match a predetermined color value the mix recipe can be automatically generated. Additionally, where a color matches a library color value, the mix recipe can be automatically generated. Further, where a target color map requires a number of mix recipes, the system can generate individual, or custom, mix recipes for the color of each point of the color map in relation to that point's location on the map and the target surface to which it will be applied.

The system can generate manufacturing specifications which can include, but is not limited, to the following: property specifications, color specifications, topographical specifications, color recipes, mixing recipes, mixing instructions, machining instructions and finishing requirements. Different machine and manufacturing processes for restorations executed and can be controlled, which include but are not limited to the following, wet and dry processing and processing with diamond tools and carbide tools.

Where the topography of a restoration is to be manufactured, the topographical map can be determined from a source of topographical data. A target topographical map can be produced either electronically or manually and input in, or used, with the system to manufacture a restoration having the target topography.

The specifications generated in the data processing unit (320) for manufacturing can be processed further, utilized as manufacturing input data, and/or can undergo manual or electronic requirements and/or specifications review. In the embodiment of the system illustrated in FIG. 3, the manufacturing interface unit (330) can support and/or perform manufacturing specifications review, specifications modification and create manufacturing input data for systems and machines. The specifications from the manufacturing interface unit (330) can be utilized as input to the machine tool operations and control systems of the manufacturing unit (340) and operations control and feedback unit (350).

In one embodiment, a manufacturing interface unit (330) is utilized whereby, the system can support an operator of a color mixing machine by providing a mix recipe for that machine. In embodiments in which a restoration is produced, or an understructure is manufactured, the system will support, monitor or execute manufacturing activities. The activities which the system supports and/or executes include, but are not limited to, preparing an understructure, coating or laminating an understructure and finishing an understructure, preparing a restoration, coating or laminating a restoration and finishing a restoration, preparing final products. Where a product restoration or coping requires one or more layers of coatings or laminates, the system will support or execute each application of a coating or laminate.

The system will support the application of color mixes and materials to a restoration, or coping, in manufacturing. Manufacturing system supported include investment casting, manufacture with ceramic, resins, glass powders, ceramic materials, glass-ceramics, mica-containing ceramics, micaceous glass ceramics, resins, bonding materials, adhesives, metal, porcelain, porcelain fused to metal (PFM), and colorants.

The embodiment of FIG. 3 additionally discloses automated processes which include, but are not limited to, those for preparing and shaping preparations, models and surfaces, manufacturing copings and restorations, creating color mix recipes and color mixtures, applying color mixtures, applying coating and laminate materials.

The system can provide practitioners and manufacturers support for, assistance with, be utilized for, or conduct, broadly varied manufacturing activities. These activities include, but are not limited to, shaping a tooth, preparing preparation, preparation of impression, modeling of impression, preparing preparation model, coating preparation model, molding preparation model, preparing surface to coat, and preparing a surface for lamination. Cutting, milling, grinding, polishing, scintering, crystallizing, casting, drilling, electro-erosion, laser-cutting, and ultrasonic material removal are some non-limiting examples of machine steps which can be utilized in the manufacturing unit (340).

In one embodiment a manufacturing step includes mixing and applying a colored material to an understructure. An amount of ceramic material for application to the understructure is created using the mix recipe and in the quantity desired. The colors which are mixed for application to the understructure can be of predetermined color value, custom blended during mixing, or color inputs can be modified during mixing to achieve the target color. Once a particular ceramic material mix is created, the ceramic mix can then be applied by a technician to the understructure in the predetermined positions according to the restoration color map. Alternatively, the system and machine tools of the system can be utilized to apply the material mix to the understructure in accordance with a color map to achieve the target color map on the understructure. In embodiments using CIM and CAM techniques for applying the material mix, mechanical applicators, spray nozzles, ink-jet print mechanisms and ink-jet type process, coating technologies such as powder coating, or ceramic coloring techniques.

In another embodiment, the application of the material mix to a surface can be repeated one or more times to create the dental restoration. For example, in one embodiment, the described method can be repeated after every layer of a ceramic material is applied to the understructure. The advantage of repeating the method after each layer is that adjustments in color can be made as necessary. For example, the exact color value of an applied layer can be determined before adding a subsequent layer. Depending upon the color value determined from the applied layer, the originally determined mix recipe for each layer can still be applied, or the mix recipe for one or more subsequent layers can be adjusted utilizing the color data collected from the applied layer.

The process operation control and feedback unit (350) of the system can be utilized to monitor the progress of work-in-progress restorations. The system can monitor the quality of the application of mixed materials with regard to thickness, uniformity, color and curing. Color mapping of the work-in-progress restoration can be used after each coating, or a lamination of a product in-process can be compared to a target color map. Such data can be processed by the system to prepare, or modify, the mix recipes for subsequent layers. This process can be repeated until the target color map is achieved upon the restoration or manufactured product.

In an embodiment having a topographical target map from which it is to be manufactured, an imaging step, or a mapping step, can be utilized to create a topographical map or 3-D map of the work-in-progress restoration. This map can be compared to the target map, or can be used separately, for evaluation of the product at that stage. Repeating this process in conjunction with subsequent machining can be utilized to achieve a target topography. Wherein an electronic three-dimensional profile of the desired finished dental restoration is created. The three-dimensional profile can be created, for example, by a coordinate measurement machine or by digital imaging. The three-dimensional profile is then used to as a guide in the application of the ceramic material to arrive at the desired final shape of the dental restoration, or nearly the desired final shape. In some embodiments, the application process utilizing the three-dimensional profile is accurate enough so that there is no need to sculpt the restoration.

In embodiments where the application process nearly creates the desired final shape, a machining step can be utilized. The machining step can be an automated or a manual process, wherein material is selectively removed by a technician to arrive at a desired final shape. The amount of material to be removed is advantageously less, however, because the present invention enables a more accurate application of ceramic material. In other instances, the machining step can be an automated process wherein an appropriate machine tool is operated to remove or add material according to the created three-dimensional electronic profile (e.g., topographical map, target (map)). Where topographical requirements are desired, the system will support, interface or control the machine tools used in the preparation of the desired topography.

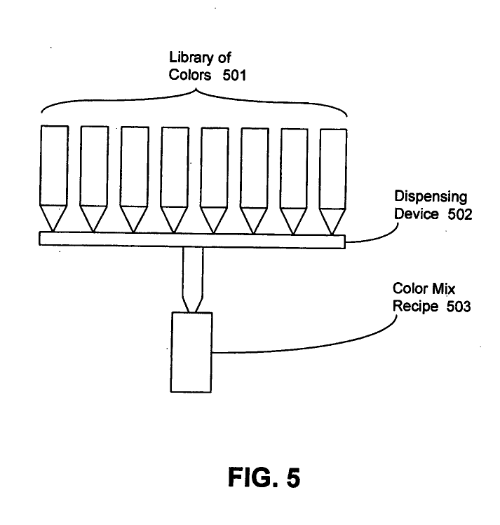

In one embodiment a generic form, a “blank”, from which a restoration is to be manufacture is provided. The data processing unit (320) accesses a color map from memory (328) under the control of the operating system (324) for use by an application program (328) for creating color maps. An application program generates a mix recipe for each point on the color map. Requirements and specifications are provided to a color mixing machine (FIG. 5) machine which produces an amount of the color material specified in the mix recipe. The color is automatically, or manually, applied to a surface of a restoration being manufactured. Optionally, the colors of the color map are each applied to the surface of the restoration being manufactured. Optionally, a second, or subsequent, color map can be created of the restoration being manufactured and compared to the color specifications and requirements which can be contained in the mix recipe. This comparison can serve as data input and a color map for another surface application of an amount of color material prepared in accordance with a corresponding second mix recipe. This process can be repeated until the layers and colors applied to the restoration match a desired, or target, color map.

In a further embodiment, the application of color materials to achieve a desired color map of a restoration can occurs in series with, or at the same time as, a machining activity. Where the application of color materials and machining activities are both executed, the restoration may in one, or more, processing steps be manufactured to achieve both a desired (or target) color map and a desired (or target) topographical map. In this further embodiment one or more comparative steps of input, restoration being manufactured and target color and topographical maps are achieved. One or more layers of colored material can be applied to the restoration being manufactured and one or more machining steps may be executed. A mix recipe having requirements and specifications for each color application can be generated.

The system can execute manufacturing processes which are closed-loop and open-loop. In the “closed-loop” embodiment, an activity is conducted entirely automatically by the system. In an “open-loop” embodiment an operator can intervene and provide feedback and control, enter data, modify specifications and requirements, and participate in the control and operation of the manufacturing step.

Where an amount of colored material is being mixed and applied the system can create a first color map for a first restoration layer, apply a first color material based upon the first color map to form the first restoration layer, evaluate the result of the application of the first color, create a second, or subsequent, color map for a second, or subsequent, restoration layer based upon the evaluation conducted, and then apply a second, or subsequent, color based upon the second, or subsequent, color map to form the second, or subsequent, restoration layer. These color processing and manufacturing steps can be repeated as many times as desired, or required, (i.e., 1 . . . n). The evaluation step can be conducted automatically by the sytem, or manually by an operator. Where the evaluation is conducted manually, the operator can input data including machine instructions, specification and processing requirements. The operation can be directly involved in the feedback, control and quality activities of manufacturing a restoration.

Where the manufacturing activity is topographical, the system for producing a dental restoration can create a first topographical map for a first machining step to an understructure or to a restoration layer, execute the first machining step based upon the first topographical map, evaluate the result of the first machining step, create a second, or subsequent, topographical map for a second, or subsequent, machining step based upon the evaluating, execute a second, or subsequent, machining step based upon the second, or subsequent, topographical map to an understructure or to a restoration layer. These topographical processing and manufacturing steps can be repeated as many times as desired, or required (i.e., 1 . . . n). The evaluation step can be conducted automatically by the sytem, or manually by an operator. Where the evaluation is conducted manually, the operator can input data including machine instructions, specification and processing requirements. The operation can be directly involved in the feedback, control and quality activities of manufacturing a restoration.

A dental restoration can be produced using both the color mixing and application process and the machining and topographical manufacturing components. The present system can execute the fully automated, or operator supported, manufacture and production of a restoration.

The system encompasses embodiments in which a variety of material application steps and material removal steps are executed. In one embodiment the system can be utilized for creating a topographical map for a restoration layer, determining an amount and location of material to be applied based on the topographical map, and applying the material to form the restoration layer. The material can be applied to any location and can be applied at a point, spot, layer, partial layer, or in any other shape and form desired. The restoration layer, or material, which has been applied can then optionally be machined to remove or affect the material, or layer, which has been applied. Whether or not machining of the applied material, or layer, is executed, a subsequent topographical map can be created for the applied restoration layer. Subsequent material can be applied based upon the subsequent topographical map. Any subsequent material which is applied can also be machined. This process of applying material to a restoration during the manufacturing process and machining the work-in-progress restoration can be performed as many times as desired.

The application of material to a surface, restoration layer, work-in-progress restoration, understructure, or restoration can be subject to process operations and control. An aspect of the control process can include the evaluation of material applied to a surface, a restoration layer, or any aspect of a work-in-progress item. The evaluation of a material which has been applied can be automatic, or manual. The data from, or associated with, an evaluation step can be processed by the system. Where the evaluation is automatic, data including any characteristic related to color or visual appearance, shape, size, amount, location, under-application of material, excess application of material, hardness, time, thickness, and/or composition can be captured, processed and utilized as input for processing not limited to creating subsequent color maps, mix recipes, manufacturing requirements, specification and instructions, and/or for process operations and control.

Manufacturing operations of manufacturing unit (340) encompass both the application of material as discussed herein, but also material removal systems. Material application and removal steps can be utilized together, sequentially, in parallel, contemporaneously, or in any combination and time sequence desired in manufacturing a restoration. Further, material application and removal steps can be used one, a number, or as many times and desired and in any combination or sequence to achieve a desired product, effect or manufacturing goal. Material removal systems encompass any machine, equipment, action, or occurrence which removes material from an object, surface, restoration layer, work-in-progress, restoration, or any object under manufacture by the system, as well as the associated computer systems and support systems. A material removal system can be automatic, manual, or include both automated and manual activities. Drills, mills, lasers, hydrocutters, sonic cutters, and saws, as well as any associated automated and/or manual operations and control systems, are non-limiting examples of material removal systems.

In one embodiment, a restoration layer is machined in accordance with a topographical map. In another embodiment, an understructure is machined prior to the application of a restoration layer.

In yet another embodiment, the system includes, but is not limited to, creating a topographical map for a restoration layer, determining an amount and location of material to be applied based on the topographical map, and applying the material to form the restoration layer. This applied material can be machined. A subsequent topographical map is then created for a subsequent restoration layer. Subsequent material is applied based upon the subsequent topographical map to form a subsequent restoration layer which can be machined. Material application and removal steps can be repeated (or executed) multiple times, or as many times as desired, in manufacturing a restoration.

A dental restoration can be produced by any combination or sequence of material application and/or material removal steps desired. A dental restoration can be produced by the system automatically, or with manual intervention. Automatic and manual activities, as well as the respective data can be utilized in any combination.

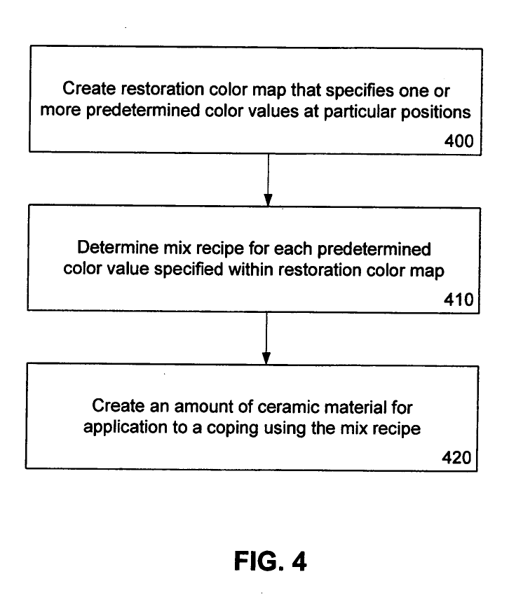

FIG. 4 is a flow chart of one embodiment of process steps for creating an amount of mixed ceramic material for application to an understructure (target understructure). In this embodiment, a restoration color map is created which specifies on or more predetermined color values to be applied at particular positions of an understructure (400). A mix recipe is determined for each predetermined color value specified within the color map (410). An amount of ceramic material for application to an understructure using the mix recipe is created (420).

FIG. 5 is an illustration of one embodiment of an apparatus for creating the a ceramic mix. The apparatus comprises colored materials which are in containers and which form a library of colors (501) which is operably connected to a dispensing device (502) for dispensing each color. A dispensing device (502) dispenses colored materials in accordance with a color mix recipe. The dispensing device is operable to dispense the desired amount of each color specified in the mix recipe. The individual color components are mixed to create the particular color mix desired. In one embodiment the color materials are ceramics. In another embodiment, the system can control the mixing machine either directly and/or by manual, or control systems operation.

In one embodiment of restoration manufacture, the process by which a dental coping can be made is the investment casting process. A mix recipe is determined by the system (or manually) and the mix recipe data is utilized to control a color mixing machine.

The system can support the operational activities which affect the supply, control and monitoring of materials and energy feeds to the manufacturing process. Further, the system can control and monitor the work-in-progress and products of the manufacturing process. The data and activities which are supported, controlled or executed by the system in material and product handling and management include, but are not limited to, manufacturing feed materials data, manufacturing feed materials handling, manufacturing feed materials inventory control, product packaging, product storage, Inventory control, product shipping, work in progress controls, and just-in time (JIT) manufacturing systems.

Applications for materials handling, operations control and feedback are illustrated (350). Applications for supporting business, financial and inventory control are also illustrated 350).

The system can support a practitioner or operating in achieve control of the entire process, or specific aspects of the process, by providing feedback and control data. Feedback and control data can be provided to the practitioner or operator and/or to processes of the system. Patient, financial, business and enterprise data can be processed by this system. Operations control and feedback activities, systems and information which can be supported by the system include, but are not limited to, operations control, control systems, manufacturing control systems, systems feedback, feedback to operations and systems, quality control, statistical quality control, data archiving, data mining, customer data, patient data, financial and accounting systems, business and enterprise systems. These activities are illustrated in the operations control and feedback unit (350) of the embodiment of FIG. 3.

The system provides support for, or control for, utilizing an apparatus, such as the mixing apparatus illustrated in FIG. 5 for creating the particular ceramic mix recipe desired.

Although this invention has been shown and described with respect to the detailed embodiments thereof, it will be understood by those skilled in the art that various changes in form and detail thereof can be made without departing from the spirit and the scope of the invention.

1. A method for producing a dental restoration; comprising the steps of:
creating a color map comprising at least one color value,
determining a mix recipe for said at least one color value,
preparing an amount of a color material from said mix recipe.

2. A method for producing a dental restoration, according to claim 1, further comprising the steps of:
providing an understructure,
applying at least some of said amount of said color material to said understructure.

3. A method for producing a dental restoration, according to claim 1, wherein said applying of said color material is by an automated device.

4. A method for producing a dental restoration, according to claim 3, wherein said automated means is an ink-jet device.

5. A method for producing a dental restoration, according to claim 3, wherein said automated device comprises a spray nozzle.

6. A method for producing a dental restoration, according to claim 3, wherein said automated device comprises an applicator.

7. A method for producing a dental restoration, according to claim 6, wherein said applicator is a paint brush, or a spatula.

8. A method for producing a dental restoration, according to claim 1, wherein said applying of said color material is in accordance with said color map.

9. A method for producing a dental restoration, according to claim 1, wherein said color map comprises electronic color value data, and wherein said preparing an amount of color material from said mix recipe produces an amount of said color material according to said electronic value color data.

10. A method for producing a dental restoration, according to claim 1, wherein said color map comprises electronic color value data and electronic positioning data which together specify a color to be applied at a location, and wherein said amount of said color is applied at said location.

11. A method for producing a dental restoration, according to claim 10, wherein said color value is a predetermined color value.

12. A method for producing a dental restoration, according to claim 1, wherein said color material comprises a ceramic.

13. A method for producing a dental restoration according to claim 2, wherein said an amount of color material is applied in a quantity specified automatically.

14. A restoration, produced using the method of claim 1.

15. A restoration, produced using the method of claim 2.

16. A method for creating a dental restoration layer, comprising
collecting color data from a patient tooth,
creating a color map utilizing said color data,
creating mix recipe data from comparison between said color data in said color map and color library data,
creating said color mixture from said mix recipe,
applying said color mixture in a thickness upon a surface forming a layer.

17. A method for creating a dental restoration layer according to claim 16, wherein said color mixture is applied in a non-uniform manner.

18. A method for creating a dental restoration layer according to claim 16, wherein said thickness varies in at least one location of said layer.

19. A method for creating a dental restoration layer according to claim 16, comprising the further steps of:
specifying a thickness of a produced layer,
predicting shrinkage of said thickness after said color mixture is applied to said surface,
executing said applying step to provide an amount of color mixture to compensate for said shrinkage.

20. A method for creating a dental restoration layer according to claim 16, wherein said surface is that of an understructure.

21. A method for creating a dental restoration layer according to claim 16, wherein said surface is that of a restoration.

22. A dental restoration, comprising multiple layers applied in accordance with the method of claim 16.

23. A dental restoration, comprising multiple layers applied in accordance with the method of claim 19.

24. A computer program product for producing a dental restoration layer, including a least one processor capable of executing program code and having a computer readable medium, the program code in said computer readable medium being used for executing steps, the steps comprising:
collecting color data from a patient tooth,
creating a color map utilizing said color data,
creating mix recipe data from comparison between said color data in said color map and color library data,
creating said color mixture from said mix recipe,
applying said color mixture in a thickness upon a surface forming a restoration layer.

25. A method for producing a dental restoration layer using a computerized system, the computerized system including a memory and a processor capable of executing program code, the program code being used to perform steps, the steps comprising:
collecting color data from a patient tooth,
creating a color map utilizing said color data,
creating a mix recipe data from comparison between said color data in said color map and color library data,
creating said color mixture from said mix recipe,
applying said color mixture in a thickness upon a surface forming a restoration layer.

26. A dental restoration, produced by the method of claim 25.

27. A method for producing a dental restoration layer using a computerized system, the computerized system including a memory and a processor capable of executing program code, the program code being used to perform steps, wherein said collecting color data from a patient tooth utilizes a digital camera, or a spectrophotometer, or a calorimeter.

28. A system for producing a dental restoration, comprising:
a data collection unit,
a data processing unit producing at least one manufacturing instruction based upon data from said data collection unit,
a manufacturing device executing said manufacturing instruction to affect production of a dental restoration.

29. A system according to claim 28, wherein said at least one manufacturing instruction is a color mix recipe.

30. A system according to claim 28, wherein said manufacturing device is a color mixing device.

31. A system according to claim 28, wherein said at least one manufacturing instruction is a color map.

32. A system according to claim 28, wherein said manufacturing device is a color material applicator.

33. A system according to claim 28, wherein said at least one manufacturing instruction is a topographical map.

34. A system according to claim 28, wherein said manufacturing device is a material removal system.

35. A system for producing a dental restoration, comprising:
creating a first color map for a first restoration layer,
applying a first color material based upon said first color map to form said first restoration layer,
evaluating said result of said applying said first color material,
creating a subsequent color map for a subsequent restoration layer based upon said evaluating,
applying a subsequent color material based upon said subsequent color map to form said subsequent restoration layer.

36. A system for producing a dental restoration according to claim 35, wherein said evaluating step is conducted automatically by said system.

37. A system for producing a dental restoration according to claim 35, wherein said evaluating step is a manual evaluating step and a result of said manual evaluating step is input into said system.

38. A system for producing a dental restoration, comprising:
creating a first topographical map for a first machining step to an understructure or to a restoration layer,
executing said first machining step based upon said first topographical map,
evaluating said result of said first machining step,
creating a subsequent topographical map for a subsequent machining step based upon said evaluating,
executing a subsequent machining step based upon said subsequent topographical map to an understructure or to a restoration layer.

39. A system for producing a dental restoration according to claim 38, wherein said evaluating step is conducted automatically by said system.

40. A system for producing a dental restoration according to claim 38, wherein said evaluating step is a manual evaluating step and a result of said manual evaluating step is input into said system.

41. A dental restoration, produced using the system of claim 35.

42. A dental restoration, produced using the system of claim 38.

43. A system for producing a dental restoration, comprising:
creating a topographical map for a restoration layer,
determining an amount and location of material to be applied based on the topographical map, and
applying the material to form the restoration layer.

44. A system for producing a dental restoration according to claim 43, further comprising the step of:
machining said restoration layer in accordance with said topographical map

45. A system for producing a dental restoration according to claim 43, further comprising the steps of:
creating a subsequent topographical map for a subsequent restoration layer,
applying additional material based upon the subsequent topographical map to form a subsequent restoration layer.

46. A system for producing a dental restoration according to claim 45, further comprising the step of:
evaluating a result of applying the material.

47. A system for producing a dental restoration according to claim 46, wherein said evaluating step is a manual evaluating step and a result of said manual evaluating step is input into said system.

48. A dental restoration, produced using the system of claim 43.

49. A dental restoration, produced using the system of claim 45.
